(19) United States
(12) Patent Application Publication
(10) Pub. No.: US 2026/0109867 A1
(43) Pub. Date: Apr. 23, 2026

(54) FLUORINE-FREE TRANSPARENT SUPERHYDROPHOBIC COATING, AND PREPARATION METHOD THEREFOR AND APPLICATION THEREOF

(71) Applicants: Jilin University, Changchun (CN); Suzhou JinLan Nanotechnology Co., Ltd., Suzhou (CN)

(72) Inventors: Haitao WANG, Changchun (CN); Xianhua ZHU, Changchun (CN); Jiarui WU, Changchun (CN); Binglian BAI, Changchun (CN); Min LI, Changchun (CN); Guanjiu FANG, Suzhou (CN)

(73) Assignees: Jilin University, Changchun (CN); Suzhou JinLan Nanotechnology Co., Ltd., Suzhou (CN)

(21) Appl. No.: 19/359,751

(22) Filed: Oct. 16, 2025

(30) Foreign Application Priority Data
Oct. 17, 2024 (CN) 202411450647.4

(51) Int. Cl. C09D 5/16; C01B 33/145; C01B 33/16; C03C 17/02; C09D 1/00

(52) U.S. Cl. CPC C09D 5/1662; C01B 33/145; C01B 33/163; C03C 17/02; C09D 1/00; C03C 2217/213; C03C 2217/76; C03C 2218/113

(57) ABSTRACT

A fluorine-free transparent superhydrophobic coating, and a preparation method therefor and an application thereof are provided. In the preparation method, a three-dimensional network structure formed by self-assembly of a bisamide derivative (1,4-bis[(3,4-dioctyloxyphenyl)-bisamido]benzene, BPH-8) is used as a template; tetraethyl orthosilicate (TEOS) as a silica precursor is adsorbed on a surface of the template to undergo sol-gel polymerization to form silica with high transparency; then BPH-8 is removed by calcination to obtain a fibrous transparent silica surface; the silica surface is hydrophobically modified with octyltrichlorosilane to obtain a transparent superhydrophobic coating. The fluorine-free transparent superhydrophobic coating features a water contact angle of 162.7°, a sliding angle of less than 3°, and an average transmittance of visible light of 84.8%, and has good self-cleaning ability, and potential application value in the fields of architectural glass, automotive window glass, rearview mirrors, optical lenses, and solar photovoltaics.

### CROSS REFERENCE TO THE RELATED APPLICATIONS

This application is based upon and claims priority to Chinese Patent Application No. 202411450647.4, filed on Oct. 17, 2024, the entire contents of which are incorporated herein by reference.

### TECHNICAL FIELD

The present invention relates to the technical field of coating materials, and in particular, to a fluorine-free transparent superhydrophobic coating, and a preparation method therefor and an application thereof.

### BACKGROUND

In nature, many special wetting phenomena can be observed, such as lotus leaves, butterfly wings, and shark skin, the surfaces of which have excellent water-repellent properties; such a surface, having a contact angle with water droplets greater than 150° and a sliding angle less than 10°, is referred to as a superhydrophobic surface. The superhydrophobic surface has various functional characteristics, such as self-cleaning, antifouling, oil-water separation, and corrosion resistance, and can be widely applied in daily life and industrial fields. However, for optical materials or electronic devices with high requirements for transparency, such as architectural glass, automotive window glass, rearview mirrors, optical lenses, and solar panels, since the optical materials or the electronic devices are frequently exposed outdoors, the environment is easily contaminated, which reduces the transparency and affects the performance. For such applications, it is necessary to combine transparency with superhydrophobicity, so that the materials and devices maintain transparency while also having self-cleaning and antifouling properties, and therefore the development of a transparent superhydrophobic coating has great application prospects.

The construction of a superhydrophobic coating usually requires two conditions, namely a surface with a certain rough structure and a low surface free energy. From the perspective of surface roughness, the rough structure affects the transmittance of visible light, and therefore the preparation of a transparent superhydrophobic coating requires surface roughness so as to achieve a balance between superhydrophobicity and transparency. At present, various transparent superhydrophobic coatings have been prepared by methods such as vapor deposition, etching, electrochemical deposition, sol-gel, and templating. For example, Chinese Patent Publication No. CN115849295A first prepares a disordered nanoporous structure on a silicon substrate by using phase separation, dry etching and vacuum evaporation; then replicates the disordered nanoporous structure on the silicon substrate to a quartz glass substrate by ultraviolet nanoimprint technology; and finally obtains a transparent superhydrophobic coating by combining vacuum evaporation, dry etching, and low surface energy treatment using fluoroalkylchlorosilane. Chinese Patent Publication No. CN116535585A first prepares a fluorinated epoxy acrylate polymer by free radical polymerization using glycidyl methacrylate and perfluoropolyether acrylate; then prepares a fluorinated silica dispersion using nano-silica, tridecafluorooctyltriethoxysilane and γ-glycidyl etheroxypropyltriethoxysilane; and compounds the fluorinated epoxy acrylate polymer, the fluorinated silica dispersion and epoxy resin for use in a coating, and curing the coating by ultraviolet light to obtain a transparent superhydrophobic coating.

However, most of these methods have problems such as complex processes, the requirement of specialized equipment, and the use of fluorides, which greatly increase the production cost, and fluorides are difficult to degrade and easily cause health and environmental problems.

### SUMMARY

An objective of the present invention is to provide a fluorine-free transparent superhydrophobic coating, and a preparation method therefor and an application thereof. The superhydrophobic coating has good transmittance in a visible light region and does not use fluorine-containing materials, thereby reducing pollution to health and the environment. In addition, the present invention also solves the problem of complex processes of existing superhydrophobic coatings and reduces production cost.

To achieve the above objective, the present invention provides the following technical solutions.

The present invention provides a preparation method for a fluorine-free transparent superhydrophobic coating, which includes the following steps:
mixing tetraethyl orthosilicate, an organic solvent, and an acid solution, and performing hydrolysis-condensation to obtain silica sol;
under heating conditions, mixing the silica sol with BPH-8 gelator, coating the obtained hot sol on a substrate, and drying to obtain a composite xerogel coating;
calcining the composite xerogel coating to obtain a calcined coating; and
immersing the calcined coating in a modifier solution, and performing modification to obtain the fluorine-free transparent superhydrophobic coating; wherein the modifier in the modifier solution includes n-octyltrichlorosilane.

Preferably, the acid solution includes hydrochloric acid, and a mass concentration of the acid solution is 7.5-10%.

Preferably, the organic solvent includes ethanol, an amount ratio of the tetraethyl orthosilicate to the organic solvent is 3-30 mg:10 mL, and an amount ratio of the tetraethyl orthosilicate to the acid solution is 3-30 mg:0.4 mL.

Preferably, the hydrolysis-condensation is performed at a temperature of 10-30° C. for 2-3 h.

Preferably, an amount ratio of the silica sol to the BPH-8 gelator is 10-11 mL: 20 mg.

Preferably, the mixing of the silica sol with the BPH-8 gelator is performed at a temperature of 160-170° C. for 120-300 s.

Preferably, the calcination is performed at a temperature of 500-600° C. for 2-3 h.

Preferably, a concentration of the modifier solution is 2-5 wt %, and the modification is performed at a temperature of 10-30° C. for 2-3 h.

The present invention provides a fluorine-free transparent superhydrophobic coating prepared by the preparation method in the foregoing technical solution.

The present invention provides an application of the fluorine-free transparent superhydrophobic coating in the foregoing technical solution in the field of architectural glass, automotive window glass, rearview mirrors, optical lenses, or solar photovoltaics.

The present invention provides a preparation method for a fluorine-free transparent superhydrophobic coating. According to the present invention, tetraethyl orthosilicate (TEOS) is used as a silica precursor to obtain silica sol by hydrolysis-polycondensation, BPH-8 is dissolved in the heated silica sol, the obtained hot sol is uniformly coated on a substrate, BPH-8 self-assembles to form a three-dimensional network structure after cooling, TEOS is adsorbed on a fiber surface and undergoes a polymerization reaction, and a composite gel coating is finally formed. Then solvent evaporation yields a xerogel coating, and BPH-8 is removed by calcination to obtain a fibrous transparent silica surface. Subsequently, octyltrichlorosilane reacts with hydroxyl groups on the silica surface for hydrophobic modification to obtain a transparent superhydrophobic coating. The superhydrophobic coating prepared according to the present invention has excellent hydrophobicity and light transmittance, features a water contact angle of 162.7°, a sliding angle of less than 3°, and an average transmittance of visible light of 84.8%, and has a good self-cleaning ability.

The preparation process of the present invention is simple, and the prepared coating does not contain any fluorides, thereby solving the problems of complicated processes and the use of fluorides in existing superhydrophobic coatings. The preparation process has low cost, does not require precise and complicated equipment, and is environmentally friendly since fluorides are difficult to degrade and tend to cause environmental problems.

### BRIEF DESCRIPTION OF THE DRAWINGS

FIG. 1 is a schematic diagram of the hydrolysis-condensation reaction of TEOS;

FIG. 2 is a schematic diagram of the modification with n-octyltrichlorosilane;

FIG. 3 is a photograph showing the transparency effect of the coatings prepared in Examples 1 to 5;

FIG. 4 is a diagram showing the contact angles of the coatings prepared in Examples 1 to 5;

FIG. 5 is a diagram showing the transparency test results of the coatings prepared in Examples 1 to 5;

FIGS. 6A-6E are scanning electron microscope images of the coatings prepared with different TEOS concentrations, wherein FIG. 6A represents that the TEOS concentration is 0.3 mg/mL, FIG. 6B represents that the TEOS concentration is 1.0 mg/mL, FIG. 6C represents that the TEOS concentration is 1.5 mg/mL, FIG. 6D represents that the TEOS concentration is 2.0 mg/mL, and FIG. 6E represents that the TEOS concentration is 3.0 mg/ml;

FIGS. 7A-7B are diagrams showing results of a self-cleaning ability test of the coating prepared in Example 1 and an untreated glass substrate, wherein FIG. 7A is the untreated glass substrate, and FIG. 7B is the coating prepared in Example 1; and

FIG. 8 is a diagram showing the wetting states of different liquids on the surface of the coating prepared in Example 1.

### DETAILED DESCRIPTION OF THE EMBODIMENTS

In the present invention, unless otherwise specified, the required raw materials or reagents are commercially available products well known to those skilled in the art.

The present invention provides a preparation method for a fluorine-free transparent superhydrophobic coating, which includes the following steps:

mixing tetraethyl orthosilicate, an organic solvent, and an acid solution, and performing hydrolysis-condensation to obtain silica sol;

under heating conditions, mixing the silica sol with BPH-8 gelator, coating the obtained hot sol on a substrate, and drying to obtain a composite xerogel coating;

calcining the composite xerogel coating to obtain a calcined coating; and

immersing the calcined coating in a modifier solution, and performing modification to obtain the fluorine-free transparent superhydrophobic coating; wherein the modifier in the modifier solution includes n-octyltrichlorosilane.

In the present invention, the acid solution preferably includes hydrochloric acid; the mass concentration of the acid solution is preferably 7.5-10%, more preferably 7.5-8.0%.

In the present invention, the organic solvent preferably includes ethanol; the amount ratio of the tetraethyl orthosilicate to the organic solvent is preferably 3-30 mg:10 mL, more preferably 15 mg:10 mL.

In the present invention, the amount ratio of the tetraethyl orthosilicate (TEOS) to the acid solution is preferably 3-30 mg:0.4 mL, more preferably 15 mg:0.4 mL. TEOS, as a precursor for forming silica, is used to control the surface structure of the silica coating after calcination by adjusting the amount of TEOS, thereby ensuring the hydrophobicity and transparency of the coating.

In the present invention, tetraethyl orthosilicate is preferably added into an organic solvent, followed by magnetic stirring for 10 min to obtain a tetraethyl orthosilicate solution, and an acid solution is then added, and hydrolysis-condensation is performed under magnetic stirring to obtain silica sol.

In the present invention, the temperature of the hydrolysis-condensation is preferably 10-30° C., more preferably 25° C., and the time is preferably 2-3 h, more preferably 2 h. The present invention has no particular limitation on the stirring, and the stirring may be performed according to a process well known in the art.

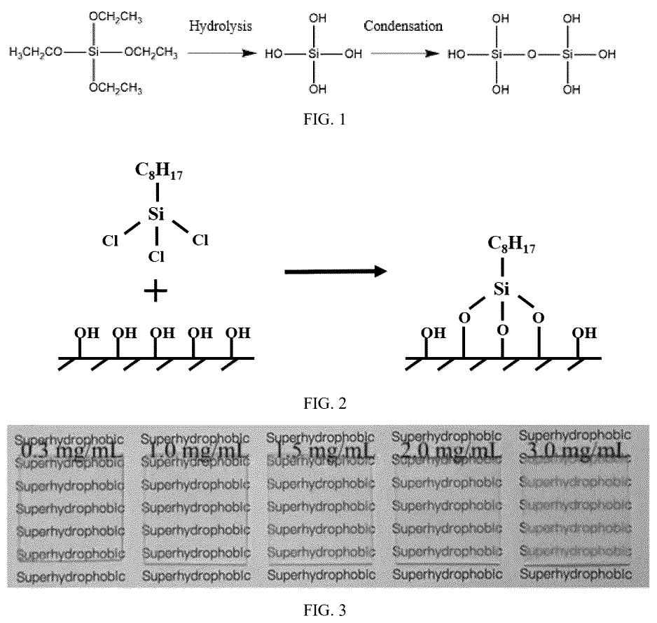

In the present invention, hydrolysis-condensation is performed under acid-catalyzed conditions (as shown in FIG. 1) to obtain silica sol containing TEOS hydrolysis-condensation products.

After the completion of the hydrolysis-condensation, post-treatment is preferably not required in the present invention, and the obtained silica sol is directly mixed with BPH-8 gelator.

In the present invention, the BPH-8 gelator is 1,4-bis[(3,4-dioctyloxyphenyl)-bisamido]benzene, which is prepared according to the method in Chinese Patent Application Publication No. CN105858592A, and the structural formula thereof is:

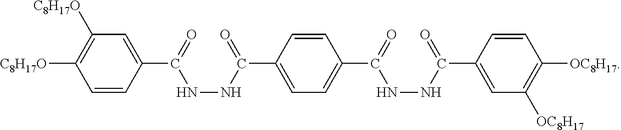

In the present invention, the mass ratio of the silica sol to the BPH-8 gelator is preferably 10-11 mL: 20 mg, more preferably 10.4-10.6 mL: 20 mg.

In the present invention, the temperature for mixing the silica sol with the BPH-8 gelator is preferably 160-170° C., more preferably 160° C., and the time is preferably 120-300 s, more preferably 150-240 s.

In the present invention, the BPH-8 gelator is preferably added into the silica sol, dissolved by heating, coated on a glass substrate, and dried for 12 h in a ventilated place to obtain a BPH-8/SiO₂ composite xerogel coating.

In the present invention, the glass substrate is not specifically limited, and corresponding substrates well known in the art can be used.

According to the present invention, a three-dimensional network structure formed by BPH-8 is used as a template to induce polymerization of TEOS hydrolysis-condensation products under acid catalysis on the surface of the template to form fibrous silica; and the size of the nano-microstructure is regulated by adjusting the amount of TEOS, thereby balancing the contradiction between transparency of the coating and structural requirements for hydrophobicity (superhydrophobicity requires the surface to have high roughness, while high roughness causes light scattering, thereby reducing transparency), so that a transparent superhydrophobic coating is prepared.

In the present invention, the temperature of the calcination is preferably 500-600° C.; and the time is preferably 2-3 h, more preferably 2 h. During the calcination process, the organic BPH-8 component is removed, and only the silica structure remains on the surface.

In the present invention, the modifier in the modifier solution includes n-octyltrichlorosilane; the concentration of the modifier solution is preferably 2-5 wt %, more preferably 3 wt %; and the solvent used in the modifier solution is preferably n-hexane. In the modification of the present invention, the calcined coating is completely immersed in the modifier solution; the amount of the modifier is determined by the modification time and the concentration of the modifier solution.

In the present invention, the temperature of the modification is preferably 10-30° C., more preferably 25° C.; and the time is preferably 2-3 h, more preferably 2 h.

As shown in FIG. 2, during the modification process, the chlorine groups in n-octyltrichlorosilane react with hydroxyl groups on the silica surface of the coating, whereby hydrophilic hydroxyl groups on the surface of the coating are significantly reduced, hydrophobic octyl groups are increased, silica is modified, and the hydrophobic performance of the coating surface is improved.

In the present invention, after the modification, the obtained product is preferably washed with ethanol and then dried, so that the fluorine-free transparent superhydrophobic coating is obtained.

The present invention provides a fluorine-free transparent superhydrophobic coating prepared by the preparation method in the foregoing technical solution.

The present invention provides an application of the fluorine-free transparent superhydrophobic coating in the foregoing technical solution in the field of architectural glass, automotive window glass, rearview mirrors, optical lenses, or solar photovoltaics. The present invention has no particular limitation on the application method. The application can be performed based on a method well known in the art.

The technical solutions provided by the present invention will be described in detail below with reference to examples, which, however, should not be construed as limiting the scope of the present invention.

### Example 1

15 mg of tetraethyl orthosilicate (TEOS) was added into 10 mL of ethanol, magnetically stirred for 10 min to obtain an ethanol solution with a TEOS concentration of 1.5 mg/mL, then 0.4 mL of hydrochloric acid aqueous solution with a concentration of 7.5 wt % was added, and silica sol was obtained after the mixture was magnetically stirred at 25° C. for 2 h.

20 mg of 1,4-bis[(3,4-dioctyloxyphenyl)-bisamido]benzene (BPH-8) gelator was added into 10.416 mL of the prepared silica sol, heated to 160° C. for dissolution, mixed for 240 s, the obtained hot sol was coated on a glass substrate to form an organic gel coating, and after the organic gel coating was dried in air for 12 h, a BPH-8/SiO₂ composite xerogel coating was obtained;

The obtained composite xerogel-coated glass was calcined at 500° C. for 2 h, the obtained product was immersed in n-hexane solution containing 3 wt % n-octyltrichlorosilane at 25° C. for 2 h, the obtained product was washed with ethanol and dried, so that the fluorine-free transparent superhydrophobic coating was obtained.

### Example 2

The difference between this example and Example 1 is that the amount of TEOS was adjusted to 3 mg, and the superhydrophobic coating was prepared by using an ethanol solution with a TEOS concentration of 0.3 mg/mL.

### Example 3

The difference between this example and Example 1 is that the amount of TEOS was adjusted to 10 mg, and the superhydrophobic coating was prepared by using an ethanol solution with a TEOS concentration of 1.0 mg/mL.

### Example 4

The difference between this example and Example 1 is that the amount of TEOS was adjusted to 20 mg, and the superhydrophobic coating was prepared by using an ethanol solution with a TEOS concentration of 2.0 mg/mL.

### Example 5

The difference between this example and Example 1 is that the amount of TEOS was adjusted to 30 mg, and the superhydrophobic coating was prepared by using an ethanol solution with a TEOS concentration of 3.0 mg/mL.

### Test Example 1

FIG. 3 shows a photograph of transparency display effects of the superhydrophobic coatings prepared in Examples 1-5. As shown in FIG. 3, with the increase of TEOS concentration, the transparency of the coating gradually decreased, and the characters “superhydrophobic” below the coating became blurred.

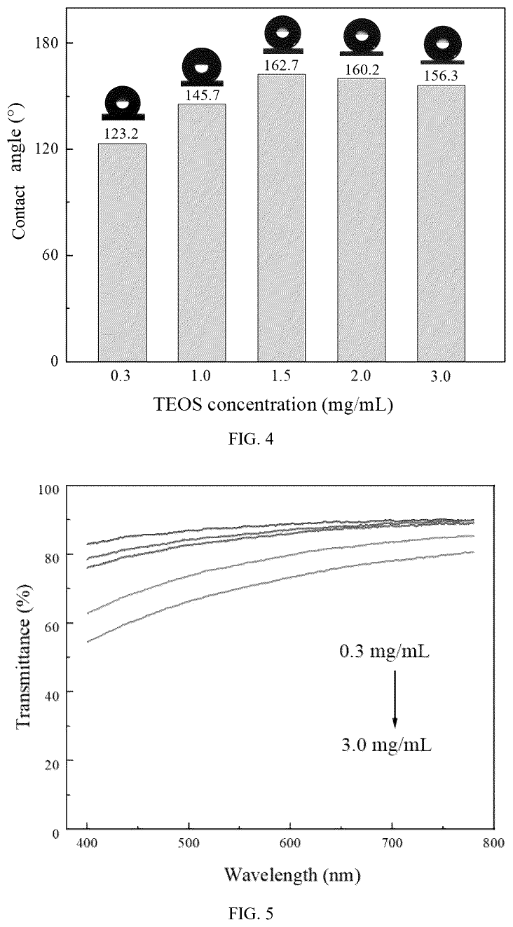

The contact angles of the coatings prepared in Examples 1-5 were measured, and the test results are shown in FIG. 4. As shown in FIG. 4, with the change of TEOS concentration, the wettability of the coating also changed. In a case where the TEOS concentration was 0.3 mg/mL, the water contact angle of the coating was 123.2°; and with the increase of TEOS concentration, the water contact angle of the coating gradually increased. In a case where the TEOS concentration increased to 1.5 mg/mL, the water contact angle of the coating increased to 162.7°; thereafter, with the further increase of TEOS concentration, the water contact angle gradually decreased; and in a case where the TEOS concentration was 3.0 mg/mL, the water contact angle was 156.3°. The above results indicated that the hydrophobicity of the coating was optimal in a case where the TEOS concentration was 1.5 mg/mL. This was because the surface roughness of the coating also increased with the increase of TEOS concentration, thereby increasing the contact angle; however, in a case where the TEOS concentration was excessively high, the surface structure of the coating changed, thereby decreasing the contact angle.

### Test Example 2

The transparency of the samples was tested by using an ultraviolet-visible spectrophotometer, the test light wavelength range was 400-780 nm, and the visible light transmittance of the coatings prepared in Examples 1-5 was measured. The test results are shown in FIG. 5. As shown in FIG. 5, with the increase of TEOS concentration, the visible light transmittance of the coating gradually decreased. The average transmittance values of the samples prepared at TEOS concentrations of 0.3 mg/mL, 1.0 mg/mL, 1.5 mg/mL, 2.0 mg/mL, and 3.0 mg/mL were 87.9%, 86.0%, 84.8%, 77.7%, and 71.1%, respectively. This was because the surface roughness of the formed coating was small and the degree of light scattering was low in a case where the TEOS concentration was relatively low, the coating exhibited high transparency, while with the increase of TEOS concentration, the surface roughness of the coating gradually increased, resulting in increasingly severe light scattering, thereby reducing the visible light transmittance of the coating.

### Test Example 3

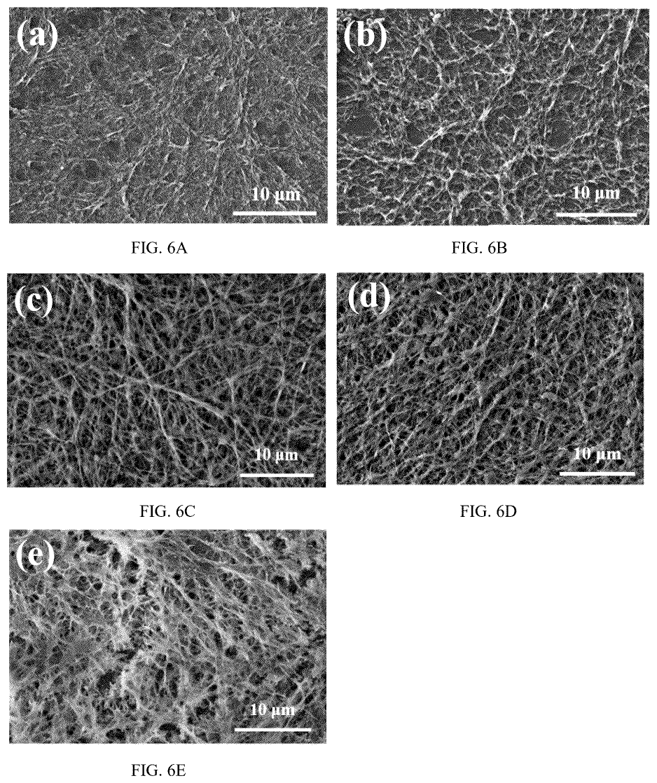

The coatings prepared in Example 1 and Example 2 were subjected to scanning electron microscopy testing, and the test results are shown in FIGS. 6A-6E.

FIG. 6A represents that the TEOS concentration is 0.3 mg/mL, FIG. 6B represents that the TEOS concentration is 1.0 mg/mL, FIG. 6C represents that the TEOS concentration is 1.5 mg/mL, FIG. 6D represents that the TEOS concentration is 2.0 mg/mL, and FIG. 6E represents that the TEOS concentration is 3.0 mg/mL.

As shown in FIG. 6A, in a case where the TEOS concentration was 0.3 mg/mL, the surface morphology of the coating was relatively flat, with only a small number of protruding structures on the surface. In a case where the concentration increased to 1.0 mg/mL, as shown in FIG. 6B, a single-layer fibrous structure appeared on the coating surface. In a case where the concentration increased to 1.5 mg/mL, as shown in FIG. 6C, the surface morphology of the coating transformed into a multilayer bundle-like fibrous structure. In a case where the concentration was 2.0 mg/mL, as shown in FIG. 6D, many block-like structures were also observed on the fibrous surface. In a case where the concentration further increased to 3.0 mg/mL, as shown in FIG. 6E, due to excessive TEOS, most of the bundle-like fibers on the coating surface transformed into sheet-like structures, and relatively deep cracks were also present.

### Test Example 4

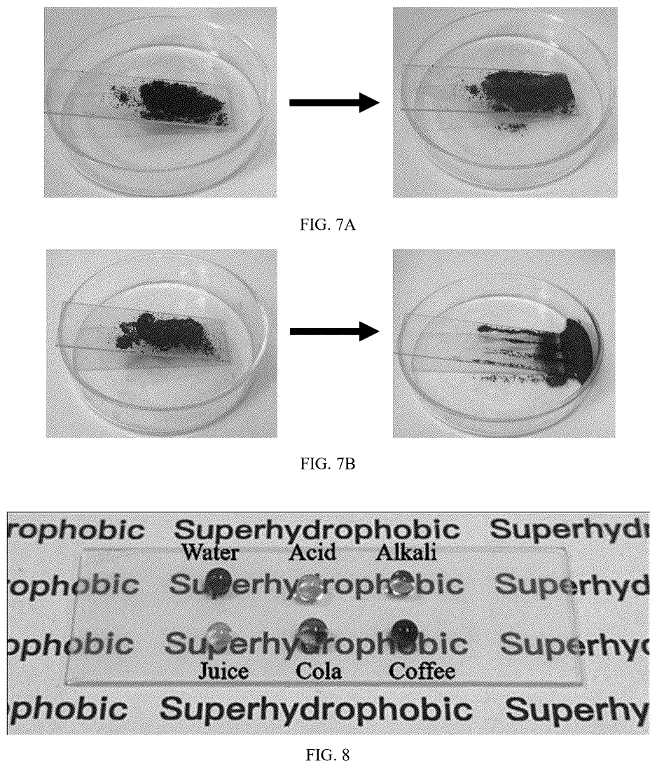

In practical applications, the superhydrophobic coating is exposed to air and frequently comes into contact with dust or liquids, while the self-cleaning property of the superhydrophobic coating makes it difficult for contaminants to adhere to the surface of the superhydrophobic coating and allows the surface contaminants to be easily removed by an aqueous solution. Therefore, the self-cleaning ability of ordinary glass (JUNBO Microscope Slides 7101) and the coating prepared in Example 1 was tested. Carbon black was used as the contaminant and placed on the surface of the samples. The samples were then placed in an inclined position, and water droplets were dropped from above to observe and test the self-cleaning performance of the samples. The test results are shown in FIGS. 7A-7B, wherein FIG. 7A shows the untreated glass substrate and FIG. 7B shows the coating prepared in Example 1.

The test result of the ordinary glass is shown in FIG. 7A. After water droplets were dripped, due to the strong adhesion of water to the ordinary glass, the droplets adhered to the glass surface and could not effectively remove the surface contaminants. The test result of the coating prepared in Example 1 is shown in FIG. 7B. After water droplets were dripped, due to the ultra-low adhesion of water to the superhydrophobic surface, the droplets rapidly rolled on the coating surface and carried away the surface contaminants, leaving no residues, which indicated that the coating prepared in Example 1 exhibited excellent self-cleaning ability.

### Test Example 5

A liquid of 20 μL was dropped on the surface of the coating prepared in Example 1, and the state of the droplet on the coating surface was observed. The wettability of different liquids (water (0.1 wt % methylene blue aqueous solution), acid (0.1 mol/L HCl solution), alkali (0.1 mol/L NaOH solution), juice (Huiyuan), cola (Coca-Cola), and coffee (Luckin Coffee)) on the surface of the coating prepared in Example 1 was tested, and the results are shown in FIG. 8.

FIG. 8 shows the wettability of various liquids on the surface of the coating prepared in Example 1. As shown in FIG. 8, the tested liquid droplets presented regular spherical shapes on the coating surface, which indicated that the coating exhibited good repellency to these liquids and excellent hydrophobic performance.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A preparation method for a fluorine-free transparent superhydrophobic coating, comprising the following steps:
mixing tetraethyl orthosilicate, an organic solvent, and an acid solution, and performing hydrolysis-condensation to obtain silica sol;
under heating conditions, mixing the silica sol with BPH-8 gelator, coating an obtained hot sol on a substrate, and drying to obtain a composite xerogel coating;
calcining the composite xerogel coating to obtain a calcined coating; and
immersing the calcined coating in a modifier solution, and performing modification to obtain the fluorine-free transparent superhydrophobic coating; wherein
a modifier in the modifier solution comprises n-octyltrichlorosilane; and
the calcination is performed at a temperature of 500-600° C. for 2-3 h.

2. The preparation method according to claim 1, wherein the acid solution comprises hydrochloric acid, and a mass concentration of the acid solution is 7.5-10%.

3. The preparation method according to claim 1, wherein the organic solvent comprises ethanol, an amount ratio of the tetraethyl orthosilicate to the organic solvent is 3-30 mg:10 mL, and an amount ratio of the tetraethyl orthosilicate to the acid solution is 3-30 mg:0.4 mL.

4. The preparation method according to claim 3, wherein the hydrolysis-condensation is performed at a temperature of 10-30° C. for 2-3 h.

5. The preparation method according to claim 1, wherein an amount ratio of the silica sol to the BPH-8 gelator is 10-11 mL: 20 mg.

6. The preparation method according to claim 1, wherein the mixing of the silica sol with the BPH-8 gelator is performed at a temperature of 160-170° C. for 120-300 s.

7. The preparation method according to claim 1, wherein a concentration of the modifier solution is 2-5 wt %, and the modification is performed at a temperature of 10-30° C. for 2-3 h.

8. A fluorine-free transparent superhydrophobic coating prepared by the preparation method according to claim 1.

9. An application of the fluorine-free transparent superhydrophobic coating according to claim 8 in a field of architectural glass, automotive window glass, rearview mirrors, optical lenses, or solar photovoltaics.

10. The preparation method according to claim 2, wherein the organic solvent comprises ethanol, an amount ratio of the tetraethyl orthosilicate to the organic solvent is 3-30 mg:10 mL, and an amount ratio of the tetraethyl orthosilicate to the acid solution is 3-30 mg:0.4 mL.

11. The preparation method according to claim 10, wherein the hydrolysis-condensation is performed at a temperature of 10-30° C. for 2-3 h.

12. The preparation method according to claim 5, wherein the mixing of the silica sol with the BPH-8 gelator is performed at a temperature of 160-170° C. for 120-300 s.

13. The fluorine-free transparent superhydrophobic coating according to claim 8, wherein in the preparation method, the acid solution comprises hydrochloric acid, and a mass concentration of the acid solution is 7.5-10%.

14. The fluorine-free transparent superhydrophobic coating according to claim 8, wherein in the preparation method, the organic solvent comprises ethanol, an amount ratio of the tetraethyl orthosilicate to the organic solvent is 3-30 mg:10 mL, and an amount ratio of the tetraethyl orthosilicate to the acid solution is 3-30 mg:0.4 mL.

15. The fluorine-free transparent superhydrophobic coating according to claim 14, wherein in the preparation method, the hydrolysis-condensation is performed at a temperature of 10-30° C. for 2-3 h.

16. The fluorine-free transparent superhydrophobic coating according to claim 8, wherein in the preparation method, an amount ratio of the silica sol to the BPH-8 gelator is 10-11 mL: 20 mg.

17. The fluorine-free transparent superhydrophobic coating according to claim 8, wherein in the preparation method, the mixing of the silica sol with the BPH-8 gelator is performed at a temperature of 160-170° C. for 120-300 s.

18. The fluorine-free transparent superhydrophobic coating according to claim 8, wherein in the preparation method, a concentration of the modifier solution is 2-5 wt %, and the modification is performed at a temperature of 10-30° C. for 2-3 h.

19. The application according to claim 9, wherein in the preparation method, the acid solution comprises hydrochloric acid, and a mass concentration of the acid solution is 7.5-10%.

20. The application according to claim 9, wherein in the preparation method, the organic solvent comprises ethanol, an amount ratio of the tetraethyl orthosilicate to the organic solvent is 3-30 mg:10 mL, and an amount ratio of the tetraethyl orthosilicate to the acid solution is 3-30 mg:0.4 mL.
